(19) United States
(12) Patent Application Publication
(10) Pub. No.: US 2013/0117580 A1
(43) Pub. Date: May 9, 2013

(54) COMPACT UNIVERSAL WIRELESS ADAPTER

(71) Applicant: Kien Hoe Daniel Chin, Singapore (SG)

(72) Inventor: Kien Hoe Daniel Chin, Singapore (SG)

(21) Appl. No.: 13/290,445

(22) Filed: Nov. 7, 2011

(51) Int. Cl. G06F 1/26

(52) U.S. Cl. 713/300

(57) ABSTRACT

A universal wireless adapter, which includes a power source, a power management element, a main processing unit, at least two serial connections, a wireless transceiver coupled to one of the at least two serial connections, wherein the transceiver is operable according to IEEE Standards 802.11b/g/n, and is capable of operating in one of an infrastructure mode and an ad hoc mode. The adapter also includes a volatile memory chip and a single non-volatile memory chip. The adapter also includes a synchronous boost voltage converter, wherein the input voltage from the battery is boosted to a higher, second voltage output. The second of at least two serial connections is a Universal Serial Bus (USB) serial connection; and a display coupled to the main processing unit, and the power source is a 2600 mAh, 3.7 volt battery. Mass-storage device couples to adapter to provide wireless access thereto.

### BACKGROUND

1. Field of the Invention

The present embodiments relate to the field of wireless adapters and, more specifically, to wireless adapters employing, for example, an IEEE Std. 802.11 communication scheme.

2. Background Art

In today's digital world, people store data on computers, and often on the Internet or Cloud, but many use portable devices like USB hard drives and flash drives when their computer space runs low. This is because these portable drives are relatively inexpensive, easy and fast to transfer data and because, unlike the Cloud, they do not require an Internet connection to access or transfer data. A disadvantage is that the user needs to physically carry the drives around. They also risk losing their data when they physically lose the drives through theft, fire, damage, etc. For data securely stored on the cloud, there is no danger of data loss and the data can be conveniently accessed from anywhere with an Internet connection. There are products that combine the speed of local storage and the convenience and security of cloud storage. However all are either not very portable, or are proprietary devices that will not work with the existing storage devices that many users already have.

### SUMMARY

The embodiments herein provide a wireless adapter, including a power source, such as a Lithium ion battery, a power management element coupled to the power source, and a main processing unit coupled to the power management element. The main processing unit further includes at least two serial connections. The wireless adapter also includes a wireless transceiver coupled to one of the at least two serial connections. Transceiver 125 may be configured to be a WiFi®, WiMax® or near-field communication device, or may be configured with two or more of such functionalities. A transceiver also can be operable according to one of IEEE Standards 802.11b, 802.11g, or 802.11n (alternately, 802.11b/g/n) and can be capable of operating in one of an infrastructure mode or an ad hoc mode, including a mesh mode. A volatile SDRAM memory chip element can be coupled to the main processing unit; also coupled to the main processing unit can be a single non-volatile memory chip element storing programming commands for the main processing unit. In addition, a synchronous boost voltage converter element can be coupled to the power source, wherein the input primary voltage (about 3.7 volts) from the battery is boosted to a higher, secondary voltage output (about 5.0 volts).

A voltage booster power line is coupled between the synchronous boost voltage converter and a second of at least two serial connections, wherein the second of at least two serial connections is a Universal Serial Bus (USB) serial connection. An LCD display is coupled to the main processing unit.

### BRIEF DESCRIPTION OF THE DRAWINGS

The invention is generally shown by way of reference to the accompanying drawings, FIG. 1 through FIG. 8 in which:

FIG. 1 is a block diagram for an embodiment, according to the teachings of the present invention;

FIG. 2A is a left side view of an assembly, according to the teachings of the present invention;

FIG. 2B a right side view of an assembly, according to the teachings of the present invention;

FIG. 3 is a front side view corresponding to the views shown in FIGS. 2A and 2B;

FIG. 4 is an exploded diagram of an outer assembly, including assemblies of FIGS. 2A, 2B, and 3, according to the teachings of the present invention; and

FIG. 5 is an illustration of a universal wireless adapter acting as an access point and link to a wireline mass access storage device, in accordance with the teachings of the present invention;

FIG. 6 is an illustration of a universal wireless adapter acting as an wireless device on an infrastructure network coupled to a router providing Internet access, in accordance with the teachings of the present invention;

FIG. 7 is an illustration of a universal wireless adapter acting as an access point to an external cellular device providing Internet access via a cellular network, in accordance with the teachings of the present invention; and

FIG. 8 is an illustration of a universal wireless adapter acting as a networked wireless device, providing wireless services to a mass storage device, in accordance with the teachings of the present invention; and

FIG. 9 is an illustration of a universal wireless adapter also having an internal cellular device and connected as both ad hoc WiFi and cellular-Internet connected device.

Some embodiments are described in detail with reference to the related drawings. Additional embodiments, features and/or advantages will become apparent from the ensuing description or may be learned by practicing the invention. In the figures, which are not drawn to scale, like numerals refer to like features throughout the description. The following description is not to be taken in a limiting sense, but is made merely for the purpose of describing the general principles of the invention.

### DESCRIPTION OF THE EMBODIMENTS

Embodiments of the invention herein may include a portable, matchbox size adapter that connects to any portable digital data mass storage device, making the data available on wireless networks and on the Cloud. The connection may be by a popular connection used on mass storage and communication devices, such as, without limitation, a USB connection. An IEEE-1394 (Firewire®) link, a USB 3.0 link, or an e-SATA link are among other communications connections which may be used. The adapter may contain a built-in battery to power the mass-storage device and a wireless (e.g. WLAN) modem to connect the data to the network. The adapter may share the data over a wireless ad-hoc network so that any WLAN-enabled device like an iPhone device, an iPad device, an Android device, a mobile phone device, a tablet device, or a computer can access the data wirelessly over a local network. Other methods of communication may be used, when an adapter is so configured, including Bluetooth®, nearfield communications, WiMax®, or another communication infrastructure, protocol, or both. The adapter can also join an existing wireless network and connect to the Internet to backup and synchronize (sync) the local drive data on the cloud, and share data with other devices connected to the wireless network of the Internet. With this adapter, users can turn nearly any (e.g. USB) mass storage device into a wireless data sharing or Cloud-enabled device.

Example embodiments of the present invention can provide a high-performance, low-power, low-cost integrated wireless adapter having elements providing power management features, a relatively long battery life, high-performance processing, a rechargeable power source, wireless communication compatibility (e.g., an IEEE 802.3b/g/n link with ad hoc and infrastructure features), and an integrated communications host port (e.g., USB OTG host port). As used herein, an element may comprise any structure arranged to perform certain operations. Each element may be implemented as hardware, software, or any combination thereof, as desired for a given set of design throughput or performance constraints. Although an embodiment may be described with a limited number of elements in a certain topology by way of example, the embodiment may include more or less elements in alternate topologies as desired for a given implementation.

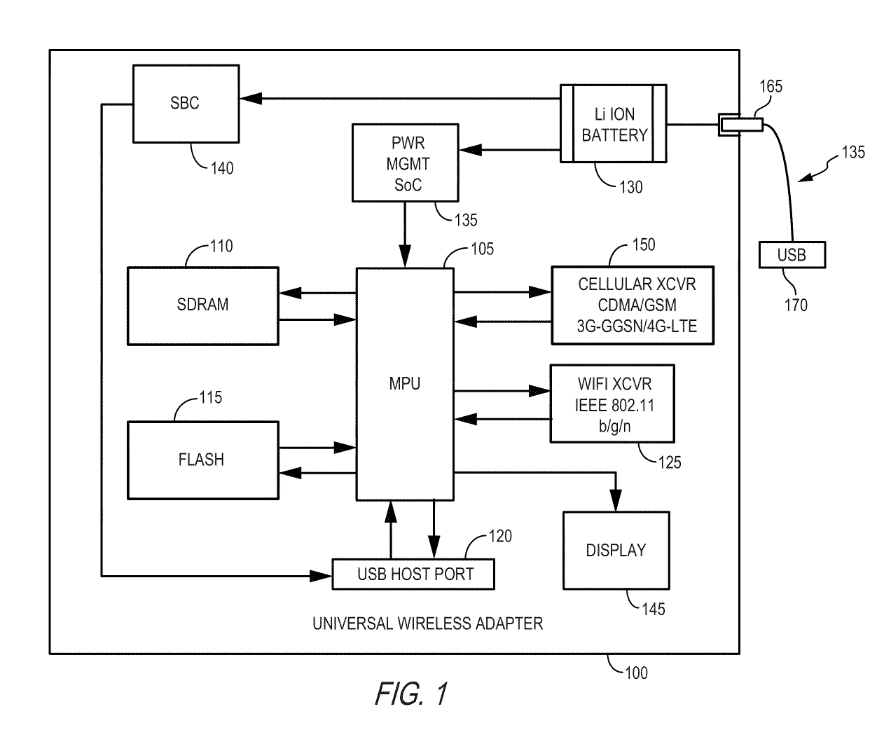

Turning to FIG. 1, system 100 can include elements such as microcontroller (MPU) 105, which bidirectionally communicates with SDRAM 110, FLASH memory 115, USB host port 120, and wireless device 125 having a wireless transceiver arranged to communicate over one or more portions of a radio-frequency (RF) spectrum, for example, frequencies for the protocols IEEE 802.11b/g/n. Power to MPU 105 is provided, for example, by a rechargeable power source element 130, which can be, for example, a high-capacity lithium-ion battery. System 100 can be designed to operate at approximately 3.3 volts, making possible the use of a single-cell lithium ion battery element for operation of system 100. In addition, power to USB host port 120 can be DC/DC up-converted (approx. 3.7 v/5.0 v) and regulated, for example, by a synchronous boost converter 140 element. Power from power source 130 and to MPU 105 can be regulated by a power management system-on-a-chip 135. MPU 105 also can control display 145, which may be a monochrome 132×32 LCD display. An example of an LCD display can be an EA DOGM132X-5 132×32 pixel LCD display, available from Electronic Assembly GmbH, Gilching, DE. MPU element 105 may be controlled in software using a LINUX® operating system, which may be stored on flash memory element 115. An SDRAM memory element can be representative of any type of suitable memory element, e.g., DDR-type or other memory element.

MPU105 can be a Sitara™ ARM® Cortex™-A8 processor (Series AM335x), produced by Texas Instruments, Inc., Dallas, Tex., USA (TI). (ARM® and Cortex™ are trademarks of ARM, Ltd., Cambridge, GB, UK). An example of a high-capacity lithium-ion battery can be a Samsung SDI ICR18650-26 3.7V (nom.) 2600 mAh lithium ion battery (Samsung SDI components available from SAMSUNG SDI, Yongin Kyunggi-do, KR). Power source 130 can be recharged via power charging system 135. Charging system 135 may include a plug 165 coupled with rechargeable power source 130, with plug 165 being coupled with a USB input port plug 170. System 135 allows module 100 to replenish the electrical power in source 130 for extended use. Although some embodiments may have only built-in WiFi® functionality via WiFi® element 125, other embodiments may include a cellular transceiver 150, which may have 3G CDMA/GSM/GGSN functionality, 4G LTE functionality, or both types of functionalities. Of course, the foregoing MPU element and other elements are representative of functionality and the embodiments are not limited to any specific devices, such as those described. In addition, the use of WiFi® herein is a convenient communication infrastructure and protocol although one of ordinary skill in the art could replace WiFi® functionality with another communication infrastructure or protocol or both.

MPU 105 can be implemented using a 650 MHz processor capable of producing high performance, for example, 1.3 Dhrystone MIPS. Such high performance supports cloud backup/sync capability and realtime image decoding for use on a wireless PC tablet or a mobile smartphone. High integration of MPU functions allows users of the wireless PC tablet or smartphone, for example, to browse digital media, including videos, from large capacity external USB storage or another data source with a USB connection. (USB products are specified by the USB Implementers Forum, OR, USA)

MPU 105 also can be configured with an SDRAM controller external memory interface element to couple directly with a single SDRAM memory chip element and with a general purpose memory controller to couple directly with a single NOR Flash memory chip element, providing GB of storage and working memory while using only a single chip footprint. Suitable SDRAM element 110 can include a HY5PS1G1631C 200 MHz 1 GB DDR2 SDRAM produced by Hynix, Icheon-si Gyeonggi-do, KR. Similarly, a suitable flash memory element 115 can be an MX25L12845E 128 MB NOR Flash memory from Macronix, Taiwan, R.O.C. Again, SDRAM and FLASH memory are functional representatives of elements, which may be used to achieve similar functionality.

MPU 105 can have at least two communication connections, such as two USB PHY interfaces, one of which may be a Multiport USB, capable of directly connecting to a USB-based wireless module such as module 125. USB drivers can be included with the interfaces. Module 125, coupled to the multiport USB connection, can be a RT3070 module from RALINK Technology Corp. (Cupertino, Calif. USA). Module 125 may support between about 150 Mbps to about 300 Mbps throughput communicated using an IEEE 802.11n (Draft 4.0) and IEEE 802.11b/g standards, and a highly efficient low-power consumption design. The IEEE 802.11 standard can define the protocol for two types of networks: Ad-hoc and client/server networks. An ad-hoc network is a simple network where communications are established between multiple stations in a given coverage area without the use of an access point or server. The standard specifies the etiquette or protocol that each station must observe so that they all have fair access to the wireless communication link. It also provides schemes for arbitrating requests to use the communication link to ensure that throughput is maximized for all users. In contrast, client/server networks use an access point that controls the allocation of bandwidth (i.e., transmission times) for all stations. As before, one of ordinary skill in the art would know to modify USB® and WiFi® connections to make a similar functionality with different communications and wireless connections. A special type of ad hoc protocol is the concept of mesh protocol, in which a nearby peer may act as a router to a more distant peer.

The wireless access point may also be used to handle traffic to and from a wired or wireless backbone. This arrangement allows for point coordination of all of the stations in the network and ensures proper handling of the data traffic as the access point routes data between the stations and to and from the network. Typically WLANs controlled by a central access point will provide better throughput performance. Module 125 can support plural wireless security standards including, without limitation, WEP 64/128, WPA, WPA2, TRIP and AES security standards. Other security standards may be used. Module 125 also may be configured to provide multiple BSSID support, thus providing a wireless functionality for an ad hoc network or an infrastructure network.

A suitable Power Management SoC element 135, a single chip power management IC element can be a TPS6507x produced by TI. System element 135 can include a battery charger, with power path management for power source 130. The charger function can be supplied, for example, by a USB port element, such as USB Host port 120, or a DC wall power charger (not shown). SoC element 135 may have separate power controllers for MPU 105 core voltage, memory voltage, and I/O voltage.

Synchronous boost converter (SBC) 140, which generates an stable DC/DC converted output, can be adjusted to realize a high efficiency power conversion rated at 5 V, 1A output, even with supply voltages as low as 1.8V. The boost converter is based on a fixed-frequency PWM controller using a synchronous rectifier, consisting of an N-channel and a P-channel MOSFET transistor, which can reach efficiency levels of as much as 96%. SBC element 140 can produce sufficient power to operate external USB devices, connected via USB host port 120. Other elements, which can provide SBC functionality may be used.

System 100 can allow multiple wireless connections, which ultimately can access the resource coupled to the USB host port 120. In an instance in which USB host port 120 is coupled to a PC or smartphone USB port, system 100 enables the PC or smartphone to couple with other resources to which the PC or smartphone may be coupled, including the Internet.

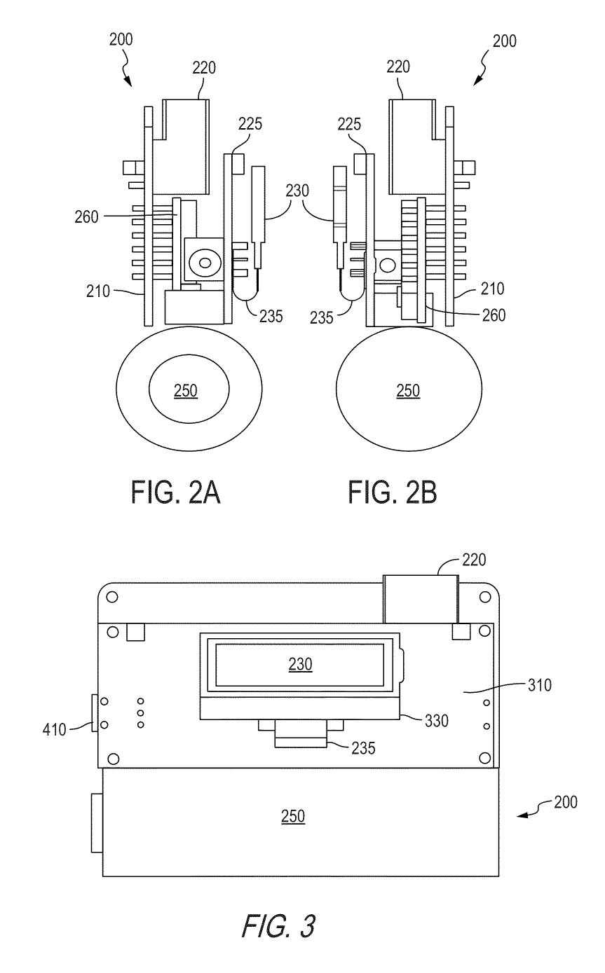

FIGS. 2A and 2B illustrate left side and right side, respectively, of system assembly 200 which can be used for system 100, shown in FIG. 1. Beginning with the left side (FIG. 2A), main system PCB 210, USB host port 220, power system PCB, LCD display 230, LCD connector 235, Li ion battery 250, and WiFi module 260. FIG. 2B depicts the same elements from a different perspective. Main system PCB can include MPU 105, SDRAM 110, and Flash memory 115. Power system PCB 225 can include SBC 140 and LCD connector 235. WiFi module 260 can contain the chip used for IEEE 802.11b/g/n communications with the system 100.

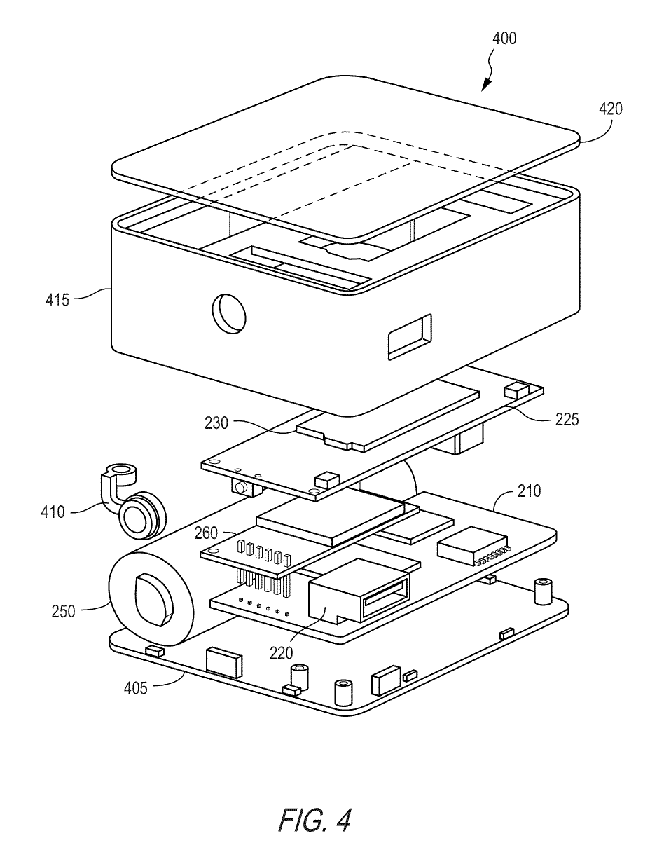

FIG. 3 illustrates the front side 310 of system assembly 200, and depicts display module 330, including a 133×32 monochrome LCD display module 330. FIG. 4 illustrates an exploded view of an enclosure 400 for assembly 200, which can include back cover 405, ON/OFF switch 410, main case 415 and top cover 420. In embodiments of the present invention, at least a portion of top cover 420 can be transparent to permit visualization of LCD display 230 below.

As can be seen, the tight integration of system components, many of which are highly integrated modules, provides a compact, versatile universal wireless adapter having an economic (matchbox-size) physical footprint (for example, less than about 75 mm×75 mm×30 mm).

### IN EXAMPLE CONFIGURATION #1

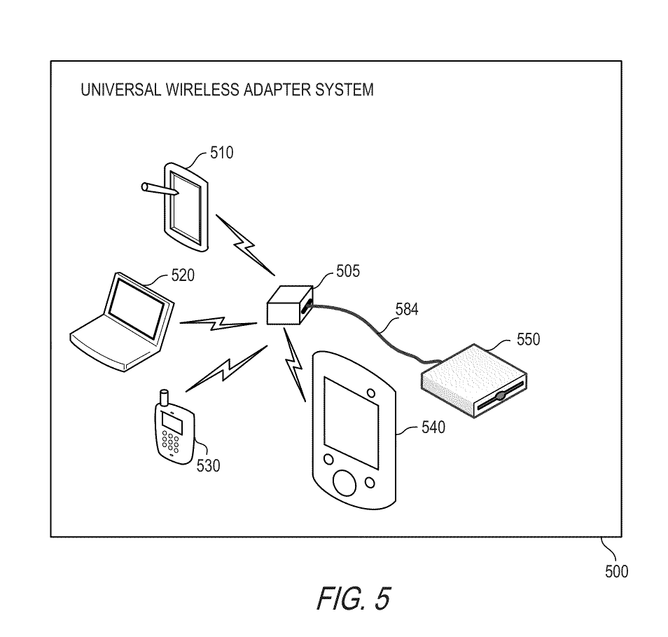

FIG. 5 illustrates a WiFi® system 500 employing a multiple BSSID capability of the universal wireless adapter 505 to connect several wireless devices (510, 520, 530, 540) to mass storage device 550 using USB connection 584. This mode can be identified as ad hoc 802.11 wireless mode, forming a peer-to-peer network. Adapter 505 also is capable of operating in infrastructure 802.11 mode, for example, as an access point for other wireless devices, or in a mesh ad-hoc mode. Wireless devices can include, without limitation, personal digital assistant 510, portable computer (laptop) 520, smart phone 530, and multifunction tablet 540, although others certainly may be used. Wireless devices (510, 520, 530, 540) couple to mass storage device 550, providing mass storage device 550 previously un-service wireless capability.

### IN EXAMPLE CONFIGURATION #2

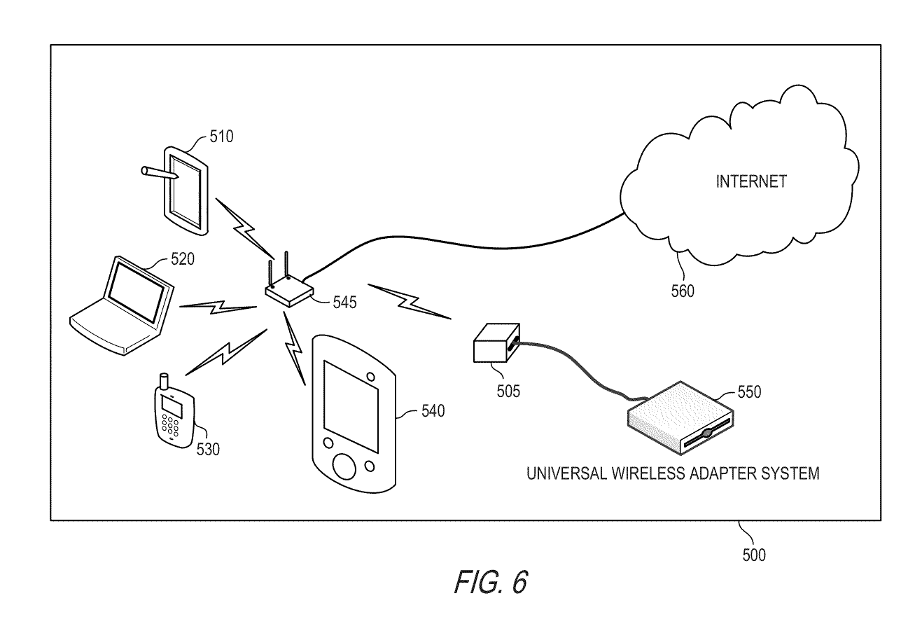

FIG. 6 illustrates a combination WiFi®/router Internet system 500 in which wireless devices (510, 520, 530, 540) can be coupled through universal wireless adapter 505 to wireline mass storage adapter 550. Wireless devices (510, 520, 530, 540) are able to communicate with and through router 545 to access the Internet. Through universal wireless adapter 505, wireline mass storage adapter 550 is able to communicate with and through universal wireless adapter 505 to communicate with router 545, providing fully wireless access to mass storage device 550. With such Internet access, mass storage device 550 can be capable of backing up some or all of stored data to the Cloud.

### IN EXAMPLE CONFIGURATION #3

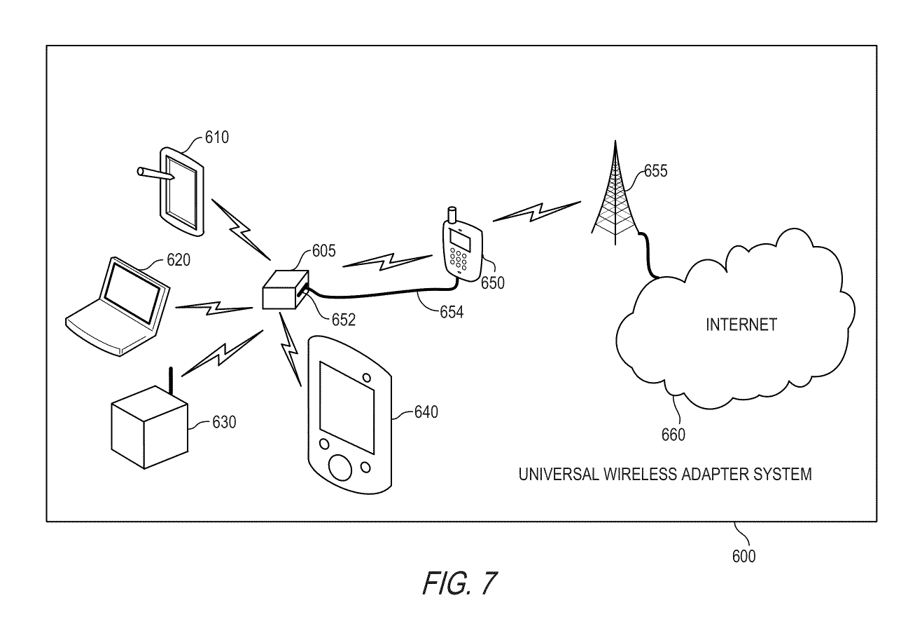

FIG. 7 illustrates a configuration in which universal wireless adapter 605 can communicate with cellular device 650 using a wired connection, e.g., USB, or a wireless connection, (e.g., Bluetooth® or dual-band WiFi®) or both. In this configuration, cellular device 650 is connected to the Internet, which permits Internet connectivity to devices 610 (PDA), 620 (laptop), 630 (wireless entertainment system, or 640 (tablet-type PC) though universal wireless adapter 605. Adapter 605 may be coupled at port 652 by USB cable 654 to smartphone 650, through to cellular network 655 and then to Internet 660. In effect, universal wireless adapter may be operating as a MiFi™ adapter providing cellular access to the Internet 660 for wireless devices 610, 620, 630, or 640. (MiFi™ is a trademark of Novatel Wireless, Inc., San Diego, Calif. USA).

### IN EXAMPLE CONFIGURATION #4

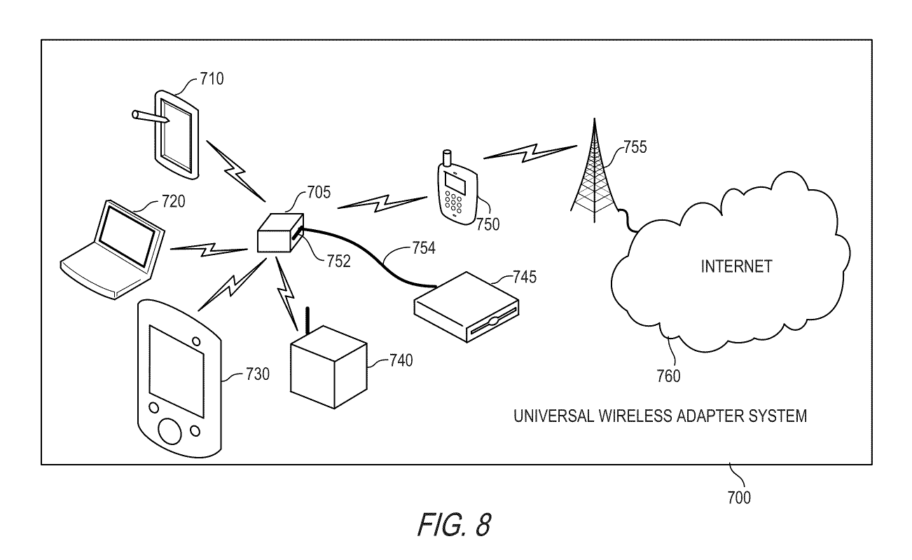

FIG. 8 illustrates yet another embodiment of a universal wireless system 700 including universal wireless adapter 705, which is coupled to smartphone 750, to cellular network 755 and then to the Internet. Adapter 705 also is coupled wirelessly to wireless devices 710, 720, 730 and 740, and via USB port 752 and cable 754 to large-capacity media storage device 745. In FIG. 7, element 710 may be a PDA, element 720 may be a laptop, element 730 may be a tablet computer, and element 740 can be a wireless entertainment system. These devices may be coupled to universal wireless adapter 705 using IEEE 802.11 b/g/n protocols. Adapter may be coupled to smartphone 750 using Bluetooth® or dual WiFi® bands Large capacity storage device may be coupled to universal wireless adapter 705 by way of a USB connection, so that the mass-storage device may wirelessly provide its contents to one one or more of other devices 710, 720, 730, 740, or 750. Smartphone 750 may be a dual-band phone (or even triple-, or quadruple-band), communicating in both WiFi® and 3G or 4G cellular frequency bands, and may have broadband capacity in a connection with the Internet, or a device or service on the Internet. This functionality can turn existing large-capacity media storage device 755 into a wireless large-capacity media storage device 755. Adapter is shown with a singular USB connection but it may be provided with a second, or additional USB connections to facilititate additional functionality in CONFIGURATION #3, or with multiple mass storage devices. As before, mass storage device 755 is capable of sharing its contents with other devices connected through adapter 705 and including Cloud-back up on Internet 760.

### IN EXAMPLE CONFIGURATION #5

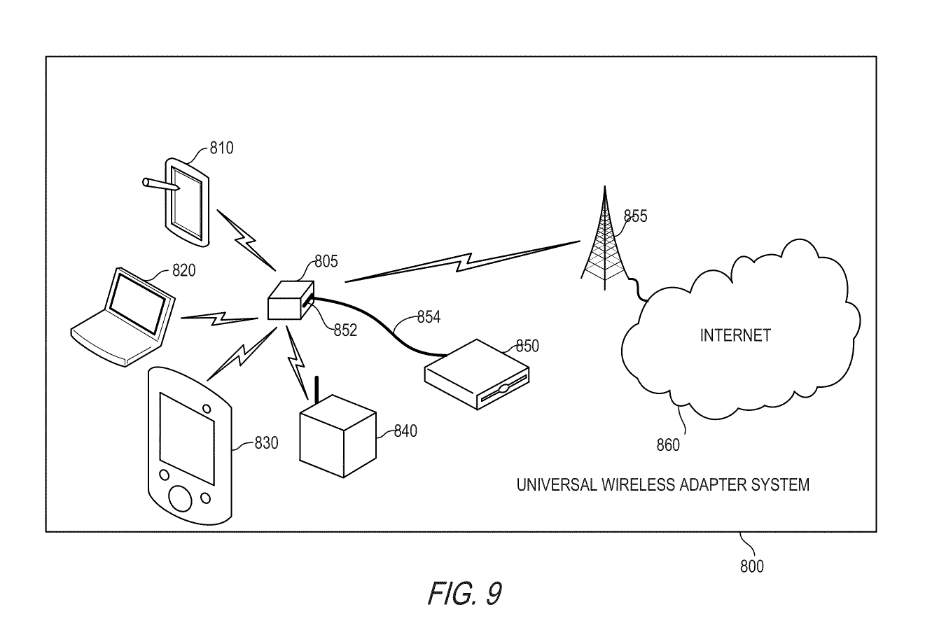

FIG. 9 illustrates a system 800 representing an embodiment of universal wireless adapter 805, similar to one in which MPU 105 in FIG. 1, which includes a cellular transceiver 150 for direct cellular connectivity. MPU 105 also may be configured with a Bluetooth® or dual-band WiFi® connections to permit connections to devices 710, 720, 730, or 740, and to provide a MiFi™-type of functionality for system 100 or 800. As in FIG. 7, system 800 of FIG. 9 can include module 805, PDA 810, laptop 820, tablet computer 830, external multimedia system 840, and high-capacity multimedia storage system 850. System 850 may be connected by port 852 via USB cable 854 to a USB port on mass storage device 850. Module 805 is similar to module 105 in FIG. 1, and including cellular functionality. With the internal cellular functionality, module 805 may communicate with a cellular system, generally at 855, which in turn, is coupled to Internet 860. At the same time, module 805 can act as a MiFi® “hotspot” in which devices 810, 820, 830 and 840 may be joined as a peer-to-peer network with mass-storage device 850. As before, the term Internet can be synonymous with remote server or cluster, “The Cloud,” or other remote computer device or service. Universal wireless adapter 805 can include a cellular radio chip allowing direct connection to cellular network 855 and then to Internet 860. Cellular capability of adapter 805 permits devices 810, 820, 830 or 840 to remain connected to the Internet while accessing mass-storage device 850 in an ad hoc mode. It is to be understood that the embodiments herein are not to be constrained by a particular mode, protocol, or instantiation of a wireline or wireless protocol or device. USB, WiFi, and cellular devices are described but other example protocols and implementations, such as USB 3.0, IEEE 1394 (Firewire), e-SATA, or WiMax® are unconstrainedly contemplated.

Although the present invention has been described in terms of example embodiments and configurations, it is to be understood that neither the Specification nor the Drawings are to be interpreted as limiting. Various alternations and modifications are inherent, or will become apparent to those skilled in the art after reading the foregoing disclosure. It is intended that the appended claims be interpreted as covering all alternations and modifications that are encompassed by the spirit and the scope of the invention. Therefore, unless such changes and modifications depart from the scope of the present invention, they should be construed as being included therein.

1. A wireless adapter, comprising:
a power source;
a power management element coupled to the power source;
a main processing unit coupled to the power management element, wherein the main processing unit further includes at least two communication connections;
a wireless transceiver coupled to one of the at least two communication connections; and
a memory coupled to the main processing unit.

2. The wireless adapter of claim 1, further comprising a single non-volatile memory chip coupled to the main processing unit, wherein the non-volatile memory stores programming commands for the main processing unit.

3. The wireless adapter of claim 1, further comprising:
a synchronous boost voltage converter coupled to the power source, wherein the input voltage from the battery is boosted to a higher, second voltage output;
a controller power line coupled between the power source and
a second of at least two communication connections, wherein the second of at least two serial connections is a Universal Serial Bus (USB) serial connection.

4. The wireless adapter of claim 2, further comprising:
a synchronous boost voltage converter coupled to the power source;
a controller power line coupled between the power source and
a second of at least two serial connections, wherein the second of at least two serial connections is a Universal Serial Bus (USB) serial connection.

5. The wireless adapter of claim 1 further comprising a display coupled to the main processing unit.

6. The wireless adapter of claim 4 further comprising a display coupled to the main processing unit.

7. The wireless adapter of claim 1, wherein the power source is a lithium ion battery.

8. The wireless adapter of claim 6, wherein the power source is a lithium ion battery.

9. The wireless adapter of claim 1, further comprising a mass-storage device communicatingly coupled to one of the at least two communication connections, wherein contents of the mass-storage device are accessible by way of the wireless transceiver.

10. The wireless adapter of claim 3 wherein the input voltage is at least 3.0 volts and the output voltage is at least 4.6 volts.

11. The wireless adapter of claim 1, wherein the transceiver is an IEEE 802.11b/g/n transceiver operable in at least one of an ad hoc mode and an infrastructure mode.

12. A wireless adapter, comprising:
a power source, including a battery;
a power management element coupled to the power source;
a main processing unit coupled to the power management element, wherein the main processing unit further includes at least two serial connections;
a wireless transceiver coupled to one of the at least two serial connections, wherein the transceiver is operable according to one of IEEE Standards 802.11b, 802.11g, or 802.11n, and is capable of operating in one of an infrastructure mode and an ad hoc mode; and
a volatile memory chip coupled to the main processing unit;
a single non-volatile memory chip coupled to the main processing unit, wherein the non-volatile memory stores programming commands for the main processing unit;
a synchronous boost voltage converter coupled to the power source, wherein the input voltage from the battery is boosted to a higher, second voltage output;
a synchronous voltage booster power line coupled between the power source and a second of at least two serial connections, wherein the second of at least two serial connections is a Universal Serial Bus (USB) serial connection; and
a display coupled to the main processing unit,
wherein the power source is a 2600 mAh, 3.6 volt battery, and
wherein the USB serial connection is coupled to a USB mass-storage device, so that the USB mass—storage device becomes a wireless mass-storage device.

13. A wireless system, comprising:
a wireless adapter including:
a power source;
a power management element coupled to the power source;
a main processing unit coupled to the power management element, wherein the main processing unit further includes at least two communications connections;
a wireless transceiver coupled to one of the at least two communications connections;
a volatile memory chip coupled to the main processing unit;
a non-volatile memory chip coupled to the main processing unit, wherein the non-volatile memory stores programming commands for the main processing unit;
a synchronous voltage booster coupled to the power source, wherein the input voltage from the battery is boosted to a higher, second voltage output;
a synchronous voltage booster power line coupled between the power source and a second of at least two communications connections;
a display coupled to the main processing unit; and
a wireless device coupled to the Internet by the wireless adapter.

14. The wireless system of claim 13, wherein the wireless device is coupled to the wireless adapter in an ad hoc 802.11 wireless mode.

15. The wireless system of claim 13, wherein the wireless device is coupled to the wireless adapter in an infrastructure 802.11 wireless mode.

16. The wireless system of claim 13, wherein the wireless device is a smartphone.

17. The wireless system of claim 14, wherein the wireless device is a tablet computer.

18. The wireless system of claim 14, wherein the wireless adapter is coupled to a mass storage device using a USB serial connection.

19. The wireless system of claim 13, further comprising:
a mass-storage device coupled to the other of the at least two communications connections, wherein the mass-storage device is a wireless mass-storage device.
